(19) United States
(12) Patent Application Publication
(10) Pub. No.: US 2017/0243165 A1
(43) Pub. Date: Aug. 24, 2017

(54) Method and apparatus for organizing a cooperative job search

(71) Applicant: James Randall Stocker, Washington, DC (US)

(72) Inventor: James Randall Stocker, Washington, DC (US)

(73) Assignee: Postlaude, LLC, Washington, DC (US)

(21) Appl. No.: 15/417,589

(22) Filed: Jan. 27, 2017

Related U.S. Application Data
(60) Provisional application No. 62/299,089, filed on Feb. 24, 2016.

(51) Int. Cl. G06Q 10/10; H04L 29/08; G06Q 50/00; G06F 17/30

(52) U.S. Cl. CPC G06Q 10/1053; G06F 17/30864; H04L 67/306; G06Q 50/01

(57) ABSTRACT

The present invention is a method and apparatus for providing support for job searchers through a social network. Based on a series of inputs, users are assigned to groups in which they support one another in their job search. User activity is then guided through a series of prompts. This makes it possible for job seekers to discuss openly their job search with others, seeking help and support from others, educating them on best practices for job searches, and helping to connect them to professional opportunities. Embodiments of the invention have myriad other applications in organizing social activity, discussion, and mutual support.

### RELATED APPLICATIONS

This application claims the benefit of U.S. Prov. App. No. 62/299,089 filed on Feb. 24, 2016, the entire content of which is hereby incorporated by reference.

### BACKGROUND

### Field of the Invention

The invention relates to a method and apparatus for organizing job seekers to support one another in their job search process via a social network.

### PRIOR ART

The following is a list of some prior art that presently appears relevant:

### U.S. Patents

U.S. Pat. No. 8,713,000 to Elman, et al. (2014)
U.S. Pat. No. 8,938,512 to Jackson, et al. (2015)
U.S. Pat. No. 8,935,346 to Jackson, et al. (2015)

### Books and Documents

Alison Doyle, “The About.Com Guide To Job Searching: Tools and Tactics to Help You Get the Job You Want”, Adams Media, 2006, pp. 191-2.
Susan Britton Whitcomb, “Job Search Magic: Insider Secrets from America's Career and Life Coach”, JIST Works, 2006, pp. 174-5.
LinkedIn, 2015 10-k Report, pp. 5-7, available at http://investors.linkedin.com/sec.cfm.

Job searching is a near universal experience. Nearly all employed adults must at some point seek out and find their own employment, which is an enormous challenge.

Although job seekers are seeking employment for themselves alone, job searching is an inherently social activity. In conducting a job search, job seekers traditionally draw on a variety of contacts for assistance, including friends, family, coworkers, teachers, fellow students, guidance and career counselors, and others. The purposes of these social aspects of a job search are numerous and varied. They include learning from the experience of others, receiving advice about how to conduct various aspects of the job search, and sharing and establishing contacts that could lead to specific opportunities in their chosen fields of employment.

While these traditional social methods of conducting a job search often yield success, they have disadvantages. In many cases, pre-existing networks of support cannot be utilized for a variety of reasons, including that the job seeker may not wish to disclose information about their job search, that their pre-existing network of contacts may not have useful expertise or knowledge that could benefit the searcher, or that members of the job searcher's existing network may simply not be willing to devote enough time or attention to helping the job seeker to locate employment or learn job search skills.

In addition to the traditional methods of job seeking outlined above, during the job search process, many searchers extend their personal network through participation in informational interviews, recruitment sessions, job fairs, alumni association events, and other events. However, while such activities can be useful, they also have numerous disadvantages. When beginning the process of job searching, job seekers must navigate these activities themselves without much guidance or experience. Moreover, it requires considerable time and effort to participate in these events, which may be scheduled infrequently or be difficult to access, thereby complicating and extending the length of the job search.

In a few limited cases, job searchers today can draw on online social networks to help them in their job search. LinkedIn™, for instance, sees itself as a tool for helping their members to advance their career by managing their professional identity, build professional networks, and access knowledge and insight and opportunities. Many individuals use LinkedIn™ and other similar networks as part of their job search process in order to see which of their contacts are connected to others who can lead them to employment opportunities. In this regards, U.S. Pat. No. 8,713,000 to Elman, et al. (2014) describes methods and systems for leveraging one's social-network to gain a competitive informational advantage when participating in an online marketplace. However, as described below, gaining a competitive informational advantage in the job selection process is not the only way in which a social networking system can help a user in their job search.

While such existing online social networks are useful tools for job seekers, they do not provide ideal conditions for learning job search skills, particularly for those entering or reentering the job market. For one thing, existing professional social networks tend to be designed to facilitate disclosure of information regarding their member's employment status and plans. Managing an online professional identity is inherently a public activity. However, job searches inherently require trial and error, experimentation, and failure, which are not usually things that a job seeker would want to have associated with their public professional identity and profile. Moreover, as mentioned earlier, some job searchers do not wish to make public the fact that they are searching for a job. Additionally, individuals become members in existing online social networks for differing reasons, not just job searching, so they may feel little incentive to help other members of the online social network.

Job search support groups are a long used method of providing social support to individuals who are searching for work. Traditionally, such groups meet in person in venues such as employment offices, universities, churches or other houses of worship, etc. While there are many anecdotes and some evidence that testifies to the utility of these groups, they also have a number of drawbacks. For instance, job search support groups tend to rely on volunteer organizers. Additionally, membership for practical reasons is often limited to individuals who lived in close proximity to and/or were affiliated with the host organization. Furthermore, these groups may meet sporadically or infrequently, or at a time that is not convenient to the job seeker.

Online social networks, even those with an explicitly professional orientation, have not yet created a means of reproducing the environment of a job search support group, including the creation of a private space for users to share their experiences and learn from one another. In theory, a private group could be created by a user on one of these networks that other members could be allowed to join, but there is no mechanism that explicitly allows such groups to be created or for their existence to be drawn to the attention of all members.

Moreover, there is no existing method for creating groups in online support groups that are suitable for serving as job search support groups in online social networks. U.S. Pat. No. 8,938,512 to Jackson, et al. (2015) describes a system and method for recommending groups to create in a social networking system. U.S. Pat. No. 8,935,346 to Jackson, et al. (2015) describes a system for recommending groups to join in a social networking system. However, these two related systems have numerous disadvantages that make them insufficient for creating job search support groups. For instance, these systems produce recommendations for creating or joining groups by specifically “identifying a set of users associated with each user in the set of users by the social networking system”; however, this is not a necessary step for creating a job search support group in a social network dedicated to facilitating job searches. Unassociated members may prove just as able to serve as members of the job search support group as associated members. Moreover, these systems and methods do not provide for mechanisms designed to help guide the group members' actions towards a particular set of goals, such as helping one another in their job search. Instead, they seem to assume that this action will occur organically within the group itself.

In conclusion, so far as I know, no online social network has created a means for job seekers to connect to one another automatically in job search support groups with sufficient levels of privacy and effective tools to efficiently support one another in their respective job searches. More broadly, existing group structures within existing online social networks are not capable of guiding user participation in an automated way toward the achievement of specific goals.

### SUMMARY OF THE INVENTION

The present invention is a method and apparatus for providing support for job searchers through a social network. It helps job searchers by making it possible for them to discuss openly their job search with others, seeking help and support from other job seekers, educating users on best practices for job searches, and helping to connect members to professional opportunities.

One embodiment of the invention is created using the WordPress Content Management System, relying on the BuddyPress social network plugin, and modified using a combination of PHP, JavaScript and other programming languages and libraries. However, a similar program could be created using other content management systems, such as Drupal or Joomla, or in many other languages, including Python and C++.

### DRAWINGS

### Figures

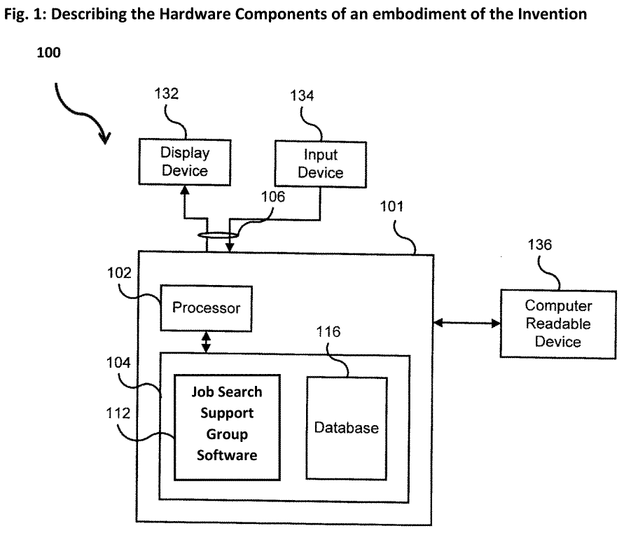

FIG. 1 is an illustration of the hardware components of an embodiment of the invention.

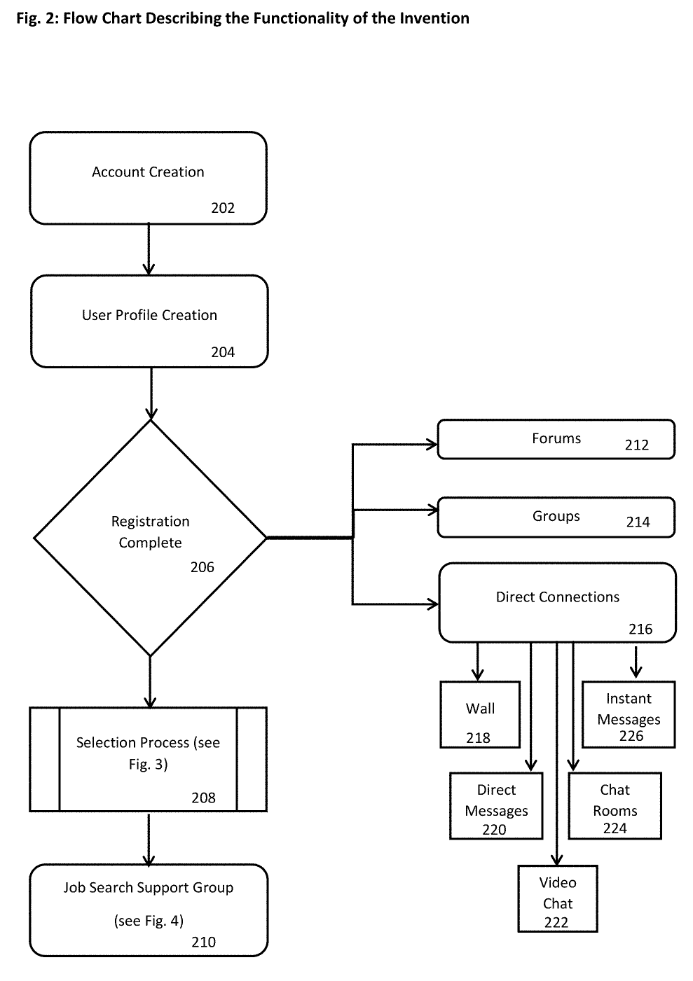

FIG. 2 is a flowchart describing the functionality of the invention.

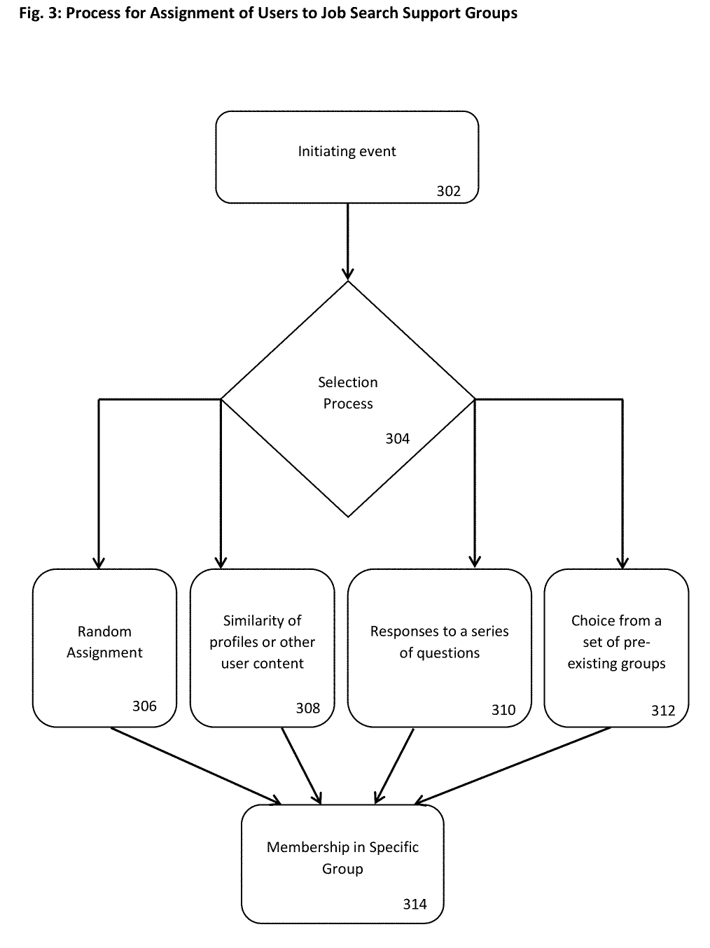

FIG. 3 is a flow chart describing the selection process used in the assignment of users to job search support groups.

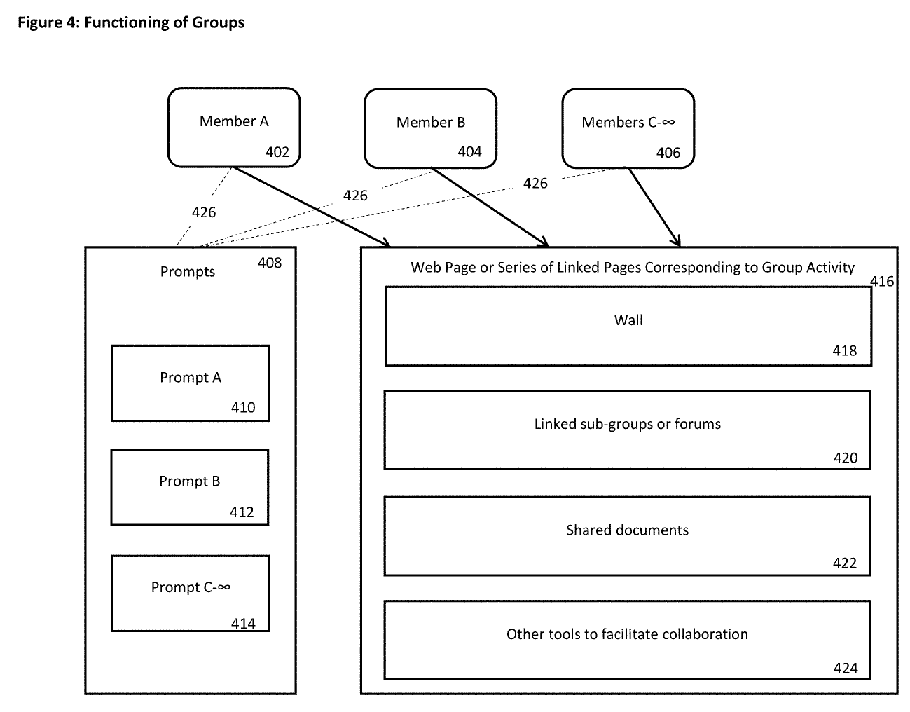

FIG. 4 is a flow chart describing the functioning of the job search support groups.

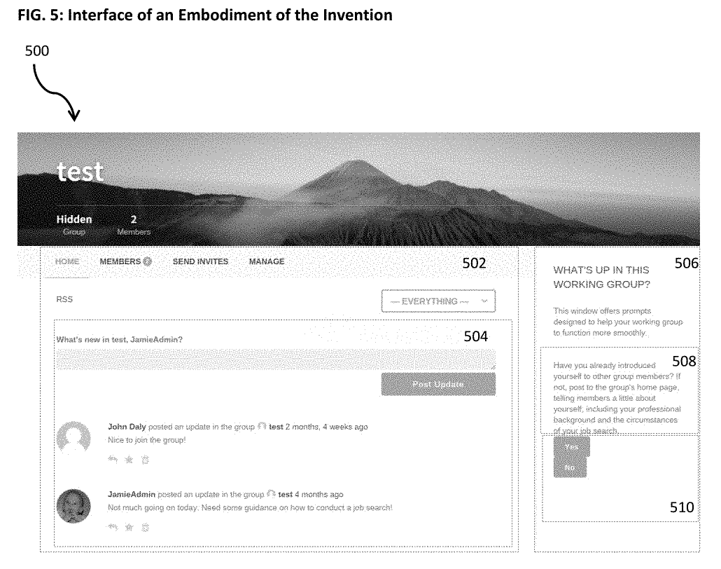

FIG. 5 is an illustration of the user interface in one embodiment of the invention.

### LIST OF REFERENCE NUMERALS

100 computer system
102 processor
104 memory
106 connection
112 job search support group software
116 database
132 display device, such as screen
134 input device, such as a mouse or touchpad
136 computer readable storage device, such as a disk drive or CD ROM device
202 registration operation
204 creation of user profile
206 user joins social network
208 selection process
210 job search support group
212 forum
214 group
216 wall or profile page
220 direct messages
222 video chat
224 chat rooms
226 instant messages
302 initiating event
304 selection process
306 random assignment
308 measured similarity of user profiles
310 user responses to series of questions
312 the user's selection of a choice from a set of pre-existing groups
314 group membership record
402 member 1
404 member 2
406 additional members beyond 1 and 2
408 prompts (questions or instructions)
410 prompt A
412 prompt B
414 additional prompts beyond A and B
416 common web page or set of web pages
418 posting activity to wall
420 subgroups
422 shared documents
424 tools to facilitate collaboration
500 an embodiment of the job search support group
502 main page
504 wall or profile page
506 area for displaying prompts
508 prompt
510 button to indicate response

### DETAILED DESCRIPTION

Referring now to the invention in more detail, in FIG. 1 there is a block diagram of a computer system 100 in accordance with an embodiment of the present invention. Computer system 100 includes a processor 102 and a memory 104. Memory 104 includes job search support group software 112 and a database 116. Database 116 contains information relating to the job search. System 100 preferably connects to a display device 132, such as a display screen, and to an input device 134, such as a mouse or touchpad. Computer system 100 also includes a computer readable storage device 136, such as a disk drive or CD ROM device. The job search support software 112 may be loaded into memory 104 via device 136.

Computer system 100 is preferably connected to a network, such as the Internet or an intranet via a connection 106. Computer system 100 includes appropriate software to enable computer system 100 to communicate with other computer systems over connection 106.

In other embodiments, various functions of job search support group software 112 may be distributed in various computer systems of the network. It will be understood by persons of ordinary skill in the art that computer system 100 can include additional processors, memory, network connections, I/O devices, software, etc. that are not shown in the Figures for the sake of clarity of example. The present invention can be implemented on a wide variety of hardware, such as network computers (NCs) and systems that bring the World Wide Web to TV and mobile devices.

In an alternate embodiment (not shown), computer system 100 includes an interactive telephone input system (not shown) that allows the user to input attraction or interests to job search support group software 112 using the keys on a touchtone telephone or a similar device.

In other embodiments, various functions of job search support group software 112 may be a part of the Web; an online website such as America Online; a business, university, government or other intranet; or part of an interactive telephone system or other network. Thus, the software 112 may be distributed in various computer systems of the network.

FIGS. 2-4 are flow charts showing steps performed in accordance with the present invention. The steps of FIGS. 2-4 are performed by processor 102 and preferably are implemented as computer instructions of software 112 executed by processor 102. Each of these flow charts is discussed below in turn.

FIG. 2 is a flow chart showing steps performed in accordance with an embodiment of the present invention to register a new user in the system and assign them to a job search support group. The registration operation 202 is generally, but not always, performed. Registration lessens the possibility of users logging on under false names and increases the security of the system. If, however, the system has only a small number of trusted users, all of whom are known to the system, then it might not be as necessary to register the users.

Users may create an account or register their personal details on a server, creating an electronic database record that establishes them as a member of a social network with an account on this network. In step 202, the job search support group software determines that a new user wants to register with the system. In step 204, the job search support group software may prompt the user to enter his or her real name and address, along with a user name, password and personal details. The user name may or may not contain parts of the user's real name. In general, users may be discouraged from using their real names, since the ability to act under a pseudonymous user name may help users to overcome hesitation they may feel towards sharing details of their job search with other users.

If a particular implementation of the invention includes a registration procedure, the user will be required to enter his or her password before he or she is able to enter new objects into the database in the future or modify a previous selection. Use of a password makes it less likely that people will log on under a false name and enter false objects into the database. Other ways that may be used to authenticate user identity include the use of public/private keys, digital signatures, or biometrics, such as fingerprint or retinal scans. In general, any appropriate method can be used to authenticate users. This step stores the user name, password, and optional personal information in memory 104. Some (though generally not all) of this personal information may be featured in a user profile, available to other-logged in members and possibly to the public.

Once this process is complete, the user generally becomes a member of the social network as per step 206. This includes creating an electronic database entry in database 116. As members of this social network, users will have access to a suite of features that are generally associated with online social networks, including but not limited to forums 212, groups 214, and direct connections to other users 216 such as a wall or profile page 218 that is unique to each user, direct messages 220, video chat 222, chat rooms 224, instant messages 226, and other methods of direct communication.

Upon becoming a member of the social network as per step 206, or at some later point triggered by either a user decision (indicated by sending a signal to the server) or a predetermined event, that user will be assigned as per selection process 208 to a specific group of other users known as the Job Search Support Group 210, all of whom are conducting a job search or otherwise are interested in advancing their careers.

FIG. 3 is a flow chart that provides an overview of selection process 208 in more detail. The process commences when one of two initiating events depicted in initiating event 302 trigger it: a registered or unregistered user makes a decision to join a Job Search Support Group, or the software decides to assign the user to a Job Search Support Group automatically in response to registration, completion of profile information, upgrading of membership status, or some other event.

Once selection process 304 begins, users may be assigned to Job Search Support Groups based on criteria such as, but not limited to, the following: 1) random assignment as per step 306; 2) the similarity of their user profiles or other previously generated user content, scored and evaluated based on some criteria of appropriateness, as per step 308; 3) based on user responses to a series of questions (then scored and grouped based on similarity) as per step 310; and/or 4) the user's selection of a choice from a set of pre-existing groups as per step 312. The group membership itself is created in step 314 and will be stored as an electronic record on computer memory 104. In some cases, the group membership entry in group 314 will require the creation of a new Job Search Support Group.

FIG. 4 is a flow chart that illustrates the functioning of an embodiment of this invention. The Job Search Support Group will be comprised of multiple members. To function correctly, it must contain a minimum of two members (402 and 404), but may also include three or more members up until infinity (406), though it is believed that more than several dozen members may produce diminished returns or even reduced effectiveness. The number of members depends upon the outcome of the process outlined in FIG. 3, or a limit on the number of members may be determined programmatically by the software. Group members may have the option to leave the group at any time.

All group members have access to a common web page or set of web pages (416) that allow group activity to be shown to other members. This activity takes the form of posting comments to a wall or common area (418) that allows these comments to be displayed sequentially, along with the responses from other group members. There may also be links to subgroups (420) where similar activity may be posted regarding specific themes. There may be a link to a page that displays shared documents (422) for the group to use. Other tools (424) designed to facilitate collaboration, such as chat rooms, videoconferences, schedulers, may also be available.

A component of the system is a subpage, displayed independently or, preferably, along with other group pages, designed to display a series of prompts (408) in the form of questions or instructions to the user regarding the sorts of content that the user could or should post to the page. The purpose of these instructions is to guide the discussion or activity of the group 11 through a series of themes that are relevant to their own job search or other tasks. Generally, these will come one at a time, though more than one could be featured at once. For instance, Prompt A (410) could be displayed, and once answered, Prompt B could appear. Once Prompt B has been answered, Prompt C could appear, and this process could be repeated as much as deemed necessary (414) to design group interactions. In each case, although the user answers the prompts (408), these prompts may be designed to ensure that user activity occurs in the common web page 416.

An example of an embodiment of this feature would be an initial prompt that asks if the member has introduced herself yet to the group, and if not, instructing her to tell the group about herself, her professional background, and her goals for her job search. The user will then know that she should introduce herself by making a post to the group web page identifying herself. Once she has done so, she can click a button to indicate that this has been accomplished. Then a subsequent prompt could appear, asking her to welcome another member to the group by responding to their comments.

Each individual prompt is programmed to display at various times, such as at regular time intervals, sequentially (i.e., once one prompt has been answered, another is displayed), or in response to user activity (such as joining the group or posting content to common page 416). The system tracks answers to responses as records in an electronic database (116) and can alter the sequence of future prompts depending on the question asked. In an alternate version, it may be possible for the software to respond to the prompts or alter the sequence of answers given by analyzing the content of information that the user has already entered in the database, including information posted in the Job Search Support Group page, profile information, wall postings, postings in groups, or chat rooms.

FIG. 5 is an illustration of the user interface in one embodiment of the invention. Image 500 shows a sample embodiment of a Job Search Support Group, which is a component of the broader social networking site. Following the creation of a Job Search Support Group, the user will be taken the group page. Area 502 contains the main part of the group's page. It includes subpages for a home area, wall or profile page. Not shown are subpages for members, a subpage for inviting other individuals to join the group, and a subpage for group administrators to manage the group. On home page 502, there is a wall or profile page 504 on which members can post comments and respond to other members. Here we see two examples of comments that are visible to all group members. Area 506 contains the functionality for displaying automatic prompts for group members. The prompt itself is displayed in area 508. Users respond in area 504, and then indicate they have responded to these suggestions or instructions by clicking one of the buttons in area 510. After this button is clicked, the existing prompt will disappear and another prompt will appear (in this case, this is made possible through JavaScript). This is only one embodiment of the invention. There are many possible combinations of layouts, components and inputs, including text inputs.

It should be noted that while the embodiments of the invention described here and displayed in the drawings are designed to support job searches, in other embodiments, the invention could be equally be used for other purposes. For instance, the system of prompts described above could be used in websites designed to facilitate discussion and/or group work, such as in a site devoted to advocacy of social causes or political perspectives, educational endeavors such as online course management systems, 12-step style addiction treatment programs, or many other contexts.

### ADVANTAGES The advantages of the present invention include, without limitation:

This method allows job searchers to share experiences and advice with other job searchers to aid each other in their respective job searches.
It provides job seekers to support one another with varying levels of privacy.
It provides opportunities for these job seekers to find each other and connect to one another more easily than through conventional methods.
Furthermore, the system serves as a motivational tool to encourage reluctant or hesitant job searchers to continue their job search through social pressure.
It automates the task of moderating group discussions through the use of prompts.

13

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

What is claimed is:

1. A method of creating a group in a social networking system such as a job search support group comprising: storing a plurality of groups as electronic records in said social networking system; storing the identities of users as electronic records in said social networking system; accessing electronic records in said social networking system to determine a user or set of users have indicated a desire for membership in a type of group; identifying a set of candidate groups of a particular type from a plurality of existing groups or creating new groups as necessary; and assigning said user or set of users to that group.

2. The method of claim 1, wherein the assignment of users to groups is determined randomly.

3. The method of claim 1, wherein the assignment of users to groups is determined based on the similarity of user profiles or other previously generated user content.

4. The method of claim 1, wherein the assignment of users to groups is determined by responses to a series of questions, which are then scored and used to measure suitability for matching.

5. The method of claim 1, wherein the assignment of users to groups is determined by user choice from a set of alternatives presented.

6. A method of organizing activity within a group on a social networking site comprising;
storing as an electronic record the existence of the group and a set of members of said group; permitting said group members or other users on the social networking site to access a page or pages commonly available to some or preferably all group members;
storing as an electronic record a set of one or more automatic prompts in the form of questions, question templates, or instructions in a database; displaying said automatic prompts in the form of questions or instructions on said page or set of pages to guide and facilitate user discussion or activity.

7. The method of claim 6 wherein the automatic prompts are stored as part of programming instructions rather than as an electronic record in a database.

8. The method of claim 6 wherein the site for the display of prompts and user activity is a forum, chat room, web page or other user interface within a social networking site, instead of a group.

9. The method of claim 6, wherein the user is allowed to respond to automatic prompts by selecting from a list of options or providing a direct response through a textbox, dropdown menu, or other programmatically generated input device.

10. The method of claim 6, wherein the sequence of the prompts is programmatically determined in advance.

11. The method of claim 6, wherein the sequence of the prompts is determined by the user.

12. The method of claim 6, wherein the sequence of the prompts is determined dynamically by the responses to the questions.

13. The method of claim 6, wherein the user discussion or activity takes place on a web page associated with the group.

14. The method of claim 6, wherein the user discussion or activity takes place in a chat room associated with the group.

15. The method of claim 6, wherein the user discussion or activity takes place on a discussion board associated with the group.

16. The method of claim 6, wherein the user discussion or activity takes place in an audio or video-linked conversation associated with the group.

17. The method of claim 6, wherein the user discussion or activity takes place on an external web site or external web application associated with the group.

18. The method of claim 6, wherein the user discussion or activity takes place in an in-person meeting.
